(19) United States
(12) Patent Application Publication
(10) Pub. No.: US 2005/0274386 A1
(43) Pub. Date: Dec. 15, 2005

(54) Method and apparatus for treatment of snoring and sleep apnea

(76) Inventor: John Macken, Santa Rosa, CA (US)

Correspondence Address: JOHNSON & STAINBROOK, LLP, 3558 ROUND BARN BLVD., SUITE 203, SANTA ROSA, CA, 95403, US

(21) Appl. No.: 10/866,058

(22) Filed: Jun. 10, 2004

(51) Int. Cl. A61G 15/00

(52) U.S. Cl. 128/848

(57) ABSTRACT

The invention provides an adhesive coated anti-snoring device that attaches to a specific area of the neck. The device exerts a predetermined force on this area of the neck, causing this area of the neck to expand outward from its normal position. This expansion opens a blockage in the throat of a sleeping person, thereby eliminating snoring and helping some people with obstructive sleep apnea.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to health and medical devices, and more particularly to an improved method and apparatus for the treatment of snoring and sleep apnea.

### BACKGROUND INFORMATION AND DISCUSSION OF RELATED ART

The fundamental cause of snoring is a restriction or blockage of the air passage in the throat. This occurs when muscles relax during sleep allowing soft tissue in the back of the throat to sag. This soft tissue then blocks the flow of air needed for breathing. Most people that snore overcome this blockage by breathing harder, and the increased air pressure partially opens up the air passage. The snoring sound is the restricted airflow vibrating the soft tissue. Besides the obvious noise, the snoring person also has laborious breathing that decreases the quality of sleep. In extreme cases of air passage blockage, there is a medical condition called obstructive sleep apnea where the quality of sleep is severely degraded.

There are hundreds of patents relating to anti-snoring devices. Almost all the mechanical devices that have been developed simply do not treat the fundamental cause of snoring because they do not open up the blocked air passage in the throat. There are two classes of mechanical anti-snoring devices that actually open up this blocked air passage. The first class opens the blocked air passage in the throat by forcing the lower jaw to jut forward to an unnatural position. However, these devices that force the lower jaw forward are very uncomfortable and can misalign the teeth.

The second class of anti-snoring devices that opens the blocked air passage in the throat utilizes an air mask, a hose and a low-pressure air compressor to inflate the lungs and air passages to a pressure typically between 70 and 120 Pascal above atmospheric pressure (a pressure between about 7 mm and 12 mm of water). This class of device is usually called a CPAP machine (Continuous Positive Airways Pressure machine). These machines are expensive, uncomfortable and restrictive. They are only used by highly motivated people that suffer from obstructive sleep apnea.

All the known prior art anti-snoring devices that utilize an adhesive are intended to be worn somewhere on the face. These devices open the nose, distort the cheek or cover the mouth. None of these prior art adhesive devices stop snoring by expanding a portion of the neck to open up the blocked air passage in the throat.

For example, the following patents utilize an adhesive device to cover the mouth: French Patent No. 78 08083 to Blander; German Patent No. DE 3837277 to Obermeler; and U.S. Pat. No. 4,817,636 to Woods.

The following patents utilize an adhesive or suction device on the nose: U.S. Pat. No. 1,292,083 to Sawyer; U.S. Pat. No. 6,631,714 to Von Duyke; U.S. Pat. No. Re. 35,408 to Petruson; and U.S. Pat. No. 3,594,813 to Sanderson.

The following patents utilize an adhesive device on the cheek: U.S. Pat. No. 3,782,372 to Carlton; and U.S. Pat. No. 5,752,524 to Corcoran.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The method and apparatus for treatment of snoring and sleep apnea of this invention provides an adhesive coated anti-snoring device that attaches to a specific area of the neck. The device exerts a predetermined force on this area of the neck, causing this area of the neck to expand outward from its normal position. This expansion opens a blockage in the throat of a sleeping person, thereby eliminating snoring and helping some people with obstructive sleep apnea.

The present invention describes how humans have two areas of the neck that will inflate when the throat is pressurized. These two areas are on the left and right side of the neck near the jaw and will be referred to as the “neck inflatable areas”. The invention provides an adhesive coated device that attaches to at least one neck inflatable area. The device causes the neck inflatable area to expand outward from its normal position by at least 2.5 mm. This external expansion causes an internal effect in the throat, which maintains an open-air passage in a sleeping person. The snoring sound is eliminated and the quality of sleep is improved. Even some people with obstructive sleep apnea are helped.

In one embodiment, the anti-snoring device is a flexible arch shape patch with two pressure pads at the base of the arch. A portion of the concave surface of the arch is adhesive coated. In use, the flexible arch is first flattened against the skin so that the adhesive attaches to at least a portion of the neck inflatable area. When released, the flexible arch recoils and pulls on a portion of the neck inflatable area with a predetermined force. This expands the neck inflatable area and opens the air passage in the throat.

In the preferred embodiment, adhesive patches are attached to both the left and right neck inflatable areas. The pulling force to expand these areas is generated by a separate springy connector that pulls both patches apart with a predetermined force. Other embodiments are disclosed which also attach to at least one of the neck inflatable areas and cause a similar expansion of this area. These other embodiments differ primarily in the way that the pulling force is generated to expand the neck inflatable area.

It is therefore an object of the present invention to provide a new and improved method and apparatus for treatment of snoring and sleep apnea.

It is another object of the present invention to provide a new and improved anti-snoring device.

A further object or feature of the present invention is a new and improved anti-snoring device, which is comfortable in use.

An even further object of the present invention is to provide a novel anti-snoring device which expands a portion of the user's neck to facilitate breathing.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty, which characterize the invention, are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to give a brief and non-technical description of the invention. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” would refer to directions in the drawings to which reference is made unless otherwise stated. The following description has numerous examples relating to the human body. Examples that refer only to the left side of the human body apply equally to the right side of the body. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 illustrates the two neck inflatable areas on a human;

FIG. 2 is a perspective view of a bridge type neck patch embodiment of an anti-snoring device of this invention as attached to a human;

FIG. 3 is a top plan view of the bridge type neck patch embodiment of the anti-snoring device depicted in FIG. 2;

FIG. 4 is a side elevation view of the bridge type neck patch anti-snoring device depicted in FIG. 2;

FIG. 5 is a perspective view of a bridge type neck patch anti-snoring device constructed with soft support pads;

FIG. 6 is a top plan view of a cantilever type embodiment of an anti-snoring device of this invention;

FIG. 7 is a side elevation view of the cantilever type anti-snoring device depicted in FIG. 6;

FIG. 8 illustrates an alternative placement of a bridge type neck patch anti-snoring device;

FIG. 9 is a perspective view of a weighted neck patch embodiment of an anti-snoring device as applied to a human;

FIG. 10 is a perspective view of the preferred embodiment; a dual patch with an elastic connector anti-snoring device as applied to a human;

FIG. 11 is a perspective view of the elastic connector device depicted in FIG. 10;

FIG. 12 is a plan view of one of the patches depicted in FIGS. 10 and 11.

FIG. 13 is a side elevation view of the adhesive patch depicted in FIG. 12.

FIG. 14 is a perspective view of an elastic connector in a tension type neck patch anti-snoring device;

FIG. 15 is a perspective view of a bridge type anti-snoring device designed to utilize magnetic attachment and adhesive tape; and

FIG. 16 is an enlarged plan view of a neck inflatable area to specify dimensions.

### DETAILED DESCRIPTION OF THE INVENTION

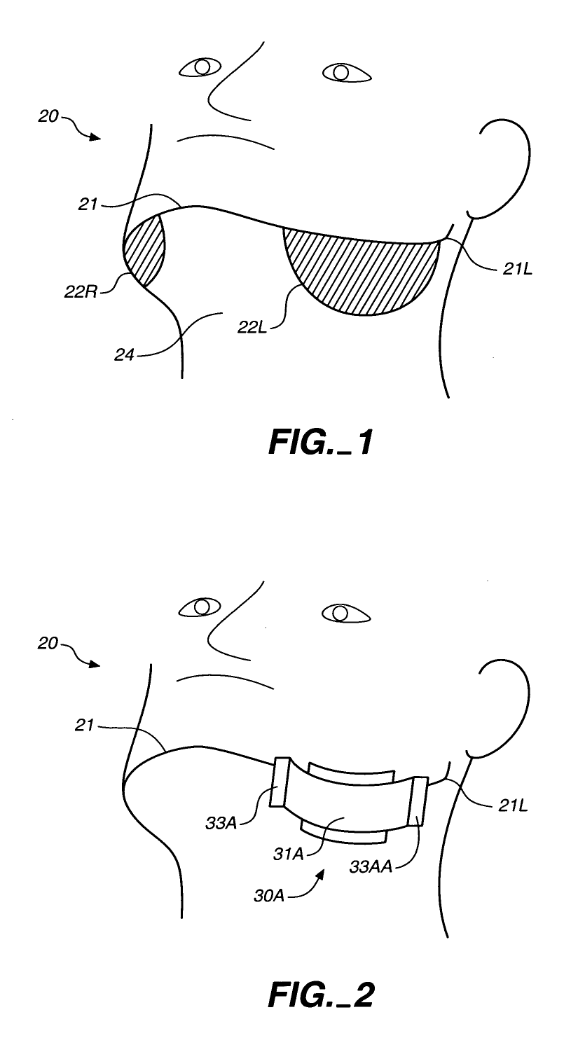

Referring to FIGS. 1 through 16, wherein like reference numerals refer to like components in the various views, there is illustrated therein a new and improved anti-snoring device.

On the human body, there are areas on the neck, which can slightly inflate. FIG. 1 shows a human 20 with a neck 24. The lower edge of the jawbone is depicted by line 21 (hereafter called the “jawbone line”). The left end of the jawbone is 21L. Below the jawbone line, 21, there are two areas (left and right) designated 22L and 22R, hereinafter referred to as “neck inflatable areas”. The reason for this name is that these areas actually expand when the throat and mouth are pressurized. For example, some trumpet players have these inflatable areas expand to a large-size when they play a trumpet. In most people, the expansion is far less noticeable, but still can be observed. One experiment is to place a finger on top of one of these areas and attempt to blow without allowing any air to escape from the mouth. This action pressurizes the throat and mouth. The internal pressure causes the neck inflatable areas to expand noticeably.

The left and right neck inflatable areas are both approximately semicircular. The exact location and size of the neck inflatable areas will be discussed later and depicted in FIG. 16. For now, the neck inflatable areas, 22L and 22R, depicted in FIG. 1 are each about 8 cm long and extend about 3 cm below the jaw line. In the following specific examples, the left side will be used, but all examples apply equally to the right side.

An experiment was performed using a flat piece of plastic that was 21 square centimeters in area. The plastic was adhered to the subject's left neck inflatable area using double coated tape. The subject then relaxed muscles in his jaw and neck. This caused the subject's breathing passage to close. Laborious breathing partly opened the breathing passage and caused a snoring sound. It was found that pulling on the plastic immediately opened the blocked air passage. In fact, it was impossible to make a snoring sound as long as there was a pulling force on the plastic and as long as the relaxed lower jaw was in a natural position slightly separated from the upper jaw.

The amount of force required to stop the simulated snoring depended on whether the head was tilted forward or back and also depended on the degree of opening between the lower and upper jaw. The simulated snoring sound stopped for a specific head position when the pulling force reached 0.25 Newton (about 25 gram force). This is equivalent to lowering the external pressure on one neck inflatable area by about 120 Pascal (about 12 mm of water). This 120 Pascal pressure reduction is the exact opposite of the 120 Pascal pressure increase sometimes used by CPAP machines to open a blocked air passage. This pressure similarity might not be a coincidence since the internal pressure exerted by CPAP machines also expands the neck inflatable areas. It is possible that some of the benefit of CPAP machines is the result of expanding of the neck inflatable areas. In any case, it appears that lowering the pressure on just the outside surface of one of the neck inflatable areas has a similar beneficial effect to raising the internal pressure on the entire respiratory system.

To be effective, the pulling force on the neck inflatable area must cause at least some of the skin on the surface of the neck inflatable area to extend beyond its normal position by a distance of at least 2.5 mm. In the remainder of this specification, a generally perpendicular surface extension of at least some portion of the neck inflatable area by a distance of at least 2.5 mm will be designated as “expanding the neck inflatable area”.

It should be pointed out that there is a considerable difference between the neck contour of a normal weight person and an obese person. A normal weight person has an indentation below the jawbone near the neck inflatable area. An obese person has a fat neck and may not have any indentation in this area. Therefore, a neck patch anti-snoring device designed for an obese person may differ somewhat in contour and size compared to devices designed for a normal weight person. However, the basic functionality and components are the same.

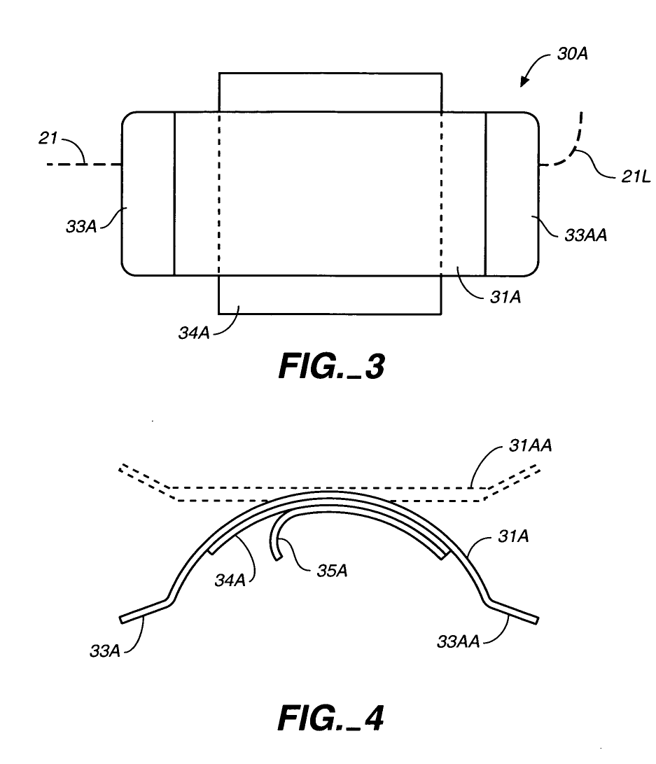

FIG. 2 shows a bridge type neck patch type anti-snoring device, 30A, attached to a human, 20. As will be described in FIGS. 3 and 4, device 30A consists of a support member 31A and an adhesive layer. The adhesive, not visible in this FIG. 2, is attached to the skin covering at least a portion of the previously designated neck inflatable area. Pads 33A and 33AA push on the skin in the vicinity of the jawbone line 21.

FIGS. 3 and 4, taken together, show the bridge type neck patch anti-snoring device, 30A, of FIG. 2. Support member, 31A, has an adhesive coating, 34A, on it's inside surface. This adhesive can be either double coated tape or an adhesive coating directly on member, 31A. FIG. 4 shows an embodiment where adhesive, 34A, is double coated tape. This double coated tape preferably extends beyond two edges of the support member, 31A as seen in FIG. 3. FIG. 4 also shows a release liner, 35A, on the surface of adhesive, 34A. Normally, this release liner would be present before the neck patch anti-snoring device is used. Just prior to application, the user would peel off liner, 35A, exposing the adhesive surface, 34A. The remainder of the discussion of FIG. 4 will presume that the release liner, 35A, has been removed.

It is most desirable for support member, 31A, to be flexible. FIG. 4 shows this flexibility. Support member, 31A, would have the shape shown by the solid line drawing in FIG. 4, when there is no force bending this support member. However, pushing on 31A can cause it to flatten as shown by the dashed line, 31AA, in FIG. 4. Once adhered to the skin, the member, 31A in FIG. 4, attempts to spring back to the solid line drawing in FIG. 4. However, since the adhesive, 34A, is now attached to the skin, the flexible support member 31A can only partly spring back to the starting shape of member 31A in FIG. 4. This exerts a predetermined pulling force on the skin that is being adhered to the adhesive, 34A. This pulling force expands the neck inflatable area and causes the skin of the neck inflatable area to protrude beyond its normal position by at least 2.5 mm.

When the anti-snoring device shown in FIG. 4 is being worn, the predetermined pulling force exerted by the flexible support member reduces the height of the arch to considerably less than the arch shown in FIG. 4. This intentional flexing also straightens out the pressure surfaces, 33A and 33AA, in FIG. 4 so that they press approximately flat on the skin over the jawbone.

It is not essential that the support member be flexible since the skin is flexible and it is possible to apply even a rigid neck patch anti-snoring device by deforming the skin sufficiently during application. However, it is most desirable to use a springy material such as springy plastic, metal, rubber or urethane for support member, 31A.

One successful device had the shape shown in FIGS. 3 and 4. This device had support member 31A made of 0.5 mm thick polycarbonate plastic, with dimensions of 7 cm×2.8 cm and an unloaded arch height of about 2 cm. The tape, 34A, extended about 6 mm beyond the top and bottom edge of the plastic. The optimum arch height varies with individuals and depends on factors such as the tightness of the skin and the degree of air passage blockage.

In FIG. 4, the ends of support member, 31A, are shown as being somewhat flattened and the flattened surfaces are designated 33A and 33AA. These will be designated as “pressure surfaces”. Most of the pushing force counteracting the pulling action of the adhesive is transmitted through these pressure surfaces. It is not necessary for them to be flattened, but this is desirable to distribute the pushing force and prevent irritation of the skin.

In FIGS. 3 and 4, the adhesive area, 34A, is shown extending beyond the edges of support member, 31A, but not extending over the entire width of the support member, 31A. This partial width coverage is easier to illustrate and seems to work well. The adhesive, 34A, is depicted as being double coated adhesive tape since it extends beyond the edge of member, 31A. This adhesive extension is desirable, but not necessary. Extending the tape, beyond the edge of member, 31A, helps the adhesion of the tape to the skin.

FIG. 3 also shows the preferred placement of the anti-snoring device, 30A, relative to the jawbone line, 21, and the left end of the jawbone, 21L. It can be seen that dashed line, 21, (representing the lower edge of the jawbone) is not centered on device, 30A. Also, pressure surface, 33AA, is near the left end of the jawbone, 21L. This positioning centers part of the arch over a sensitive point in the neck inflatable area. This will be explained further in FIG. 16.

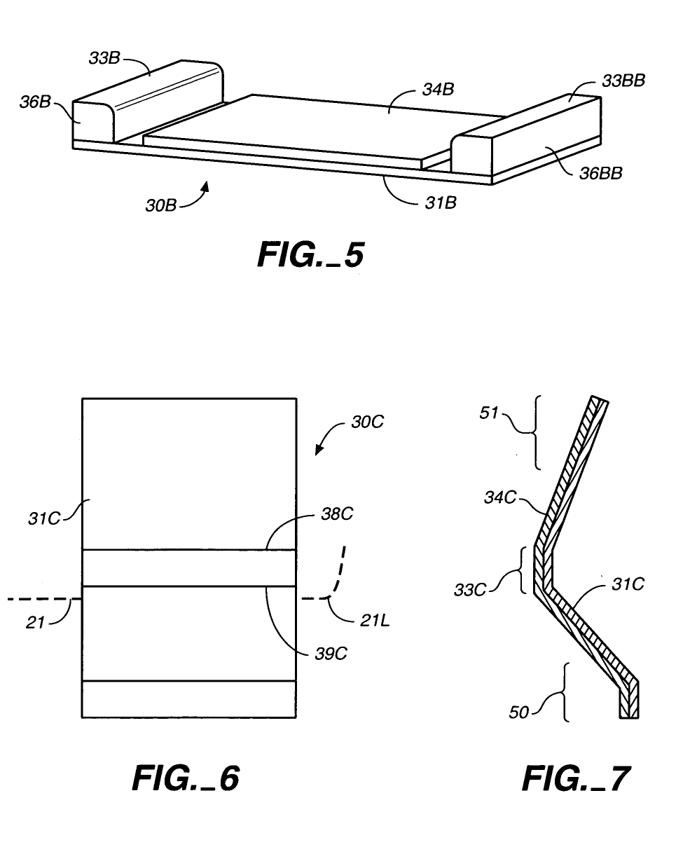

FIG. 5 shows another bridge type anti-snoring device, 30B, which is similar to device 30A illustrated in FIGS. 3 and 4. In this variation, the support member is designated 31B, the adhesive surface is 34B and the pressure surfaces are 33B and 33BB. The adhesive, 34B, is illustrated thicker than normal for clarity. In this example, support member, 31B, is shown as a generally flat material, but curved shapes are also possible. Member, 31B, can be either flexible or rigid. The key point in this embodiment is that soft pads, 36B and 36BB, have been added to member, 31B. These pads can be made of any suitable material, but the preferred material is foam rubber or foam urethane. The outer surfaces of these pads form the pressure surfaces, 33B and 33BB. These pads can also be removable or applied after the adhesive is attached to the skin.

The design depicted in FIG. 5 is shown with a similar projected shape to the design in FIG. 3. The design in FIG. 5 could also be positioned as shown in FIG. 2. However, it should be understood that the size and position of both the soft pads and the support member can be modified in any way to accomplish the goal of expanding the neck inflatable area beyond its normal position. In general, soft pads can be substituted for contours in the shape of the support member, 31, in any figure.

The term “bridge type” anti-snoring device is used to describe the devices in FIGS. 2 through 5. This is because the characteristic of a bridge type anti-snoring device is to have a central region positioned above a portion of the neck inflatable area, and between two or more supports. The device depicted in FIGS. 2, 3, and 4 has an arch shape, while the device depicted in FIG. 5 is planar. However, both devices have the characteristics of a bridge. Other bridging shapes are also possible.

FIGS. 6 and 7, taken together, illustrate a cantilever type anti-snoring device, 30C. A cantilever type anti-snoring device applies a pulling force on the desired region of the neck inflatable area by pushing on the jaw and pulling on the cheek. In FIGS. 6 and 7, there is a support member 31C, and an adhesive 34C. This device is illustrated as being bent with fold lines, 38C and 39C. Experiments have had the structural material made out of 0.5 mm thick polycarbonate plastic. When applied to a person, this flexible material straightens out somewhat compared to the amount of bend illustrated in FIG. 7.

When the device in FIGS. 6 and 7 is applied to a person, it is positioned similar to FIG. 2, except that device 30C is oriented vertically. FIG. 6 shows the proper positioning of the anti-snoring device, 30C, relative to jawbone line, 21. The left end of the jawbone is 21L. It can be seen that the proper placement of this device has the fold line, 38C, slightly above the jawbone line, 21, so that pressure surface, 33C, presses against the jawbone through the skin. The lower half of the anti-snoring device, 30C, is cantilevered out past the jawbone line, 21, and pulls on the skin of the neck inflatable area. In particular, region 50 in FIG. 7, applies the pulling force to the desired part of the neck inflatable area. More will be said about the placement when discussing FIG. 16. The cheek exerts a counterbalancing pulling force because region 51 is adhered to the cheek and the jawbone acts like a fulcrum.

Some individuals with only a slight snoring problem and tight skin may be able to have no fold lines so that support member 31C is flat. Even a flat support member will exert some pulling force on neck inflatable area, 22L. This is because a normal weight person has the skin of the neck inflatable area indented below the jawbone line, 21. Pulling this skin out with a flat surface is actually expanding the neck inflatable area by at least 2.5 mm.

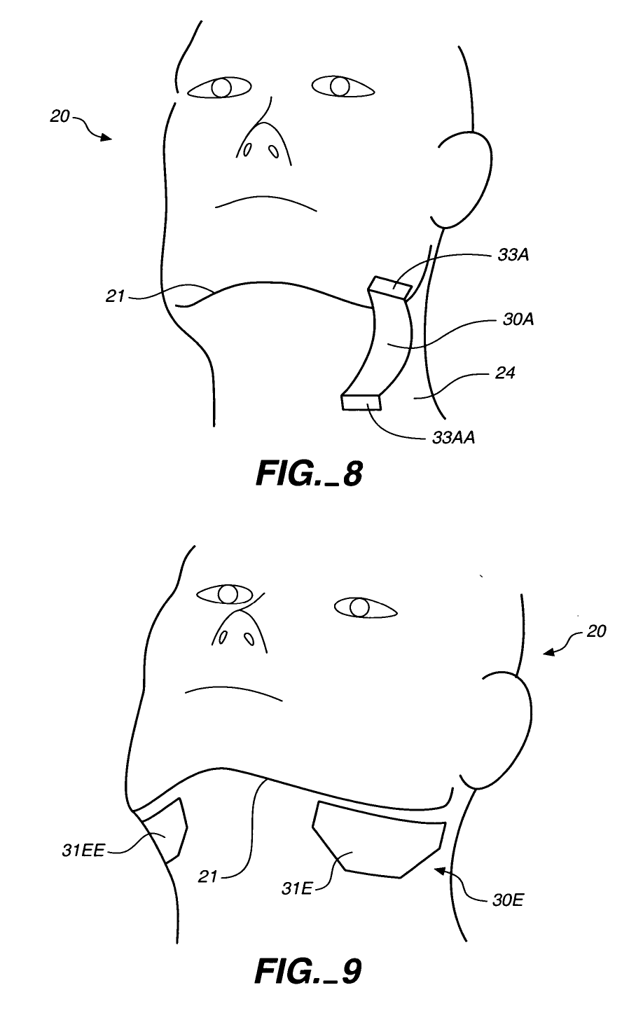

FIG. 8 should be contrasted to FIG. 2. Both figures depict a similar bridge type anti-snoring device with just a different placement. The device in FIG. 8 gains its support by one pressure surface pressing on the jaw area and another pressure surface pressing somewhere on the neck. Together, the supports counteract the pulling force that expands the neck inflatable area. Also, this anti-snoring device can use either soft pads or contoured surfaces to form the pressure surfaces.

Another type of anti-snoring device could be a three-dimensional concave dome shape. When applied to a human, this would appear similar to FIG. 8, except the pressure surface would extend around more of the periphery of the neck inflatable area. This would also be considered a bridge type anti-snoring device.

In all of these embodiments, there is 1) an adhesive, 2) a support member for the adhesive and 3) a means for exerting a predetermined pulling force (also known as a bias means). In FIGS. 2 through 8, the support member not only supported the adhesive and transferred the pulling force; the support member also performed the extra function of generating the pulling force. In FIGS. 9 through 15, the task of generating the pulling force is performed by a separate element. The support members only transfer the pulling force to the adhesive.

In FIG. 9, device 30E represents a neck patch anti-snoring device. This device is just a support member, coated with an adhesive. The key point here is that the support member, 31E, has a predetermined weight. This support member could be made out of metal, plastic, rubber, etc. The volume of this support member 31E can be adjusted to achieve the desired weight. This support member can be either flat or curved.

When a person is standing and simulating snoring, this anti-snoring device has little effect on opening the blocked air passage in the throat. However, when the person is reclining on their stomach or side, one of the two anti-snoring devices is on the downward side of the neck. The force of gravity pulling on the weighted anti-snoring device applies a predetermined force, which expands the neck inflatable area to which it is affixed. It does not matter that the other anti-snoring device, 31 EE, on the upper side of the neck is actually compressing the opposite neck inflatable area.

The optimal weight, shape, and placement can be determined by experiment and varies somewhat with different body shapes. Experiments have been performed with anti-snoring patches that had a weight of 40 grams. The weighted anti-snoring device described in FIG. 9 does not work as well if a person sleeps with a pillow pressing against the anti-snoring device. One advantage of all the other designs described herein is that they can both tolerate pillow pressure on the downward side of a sleeping person and also expand the neck inflatable area on the upward side of a sleeping person.

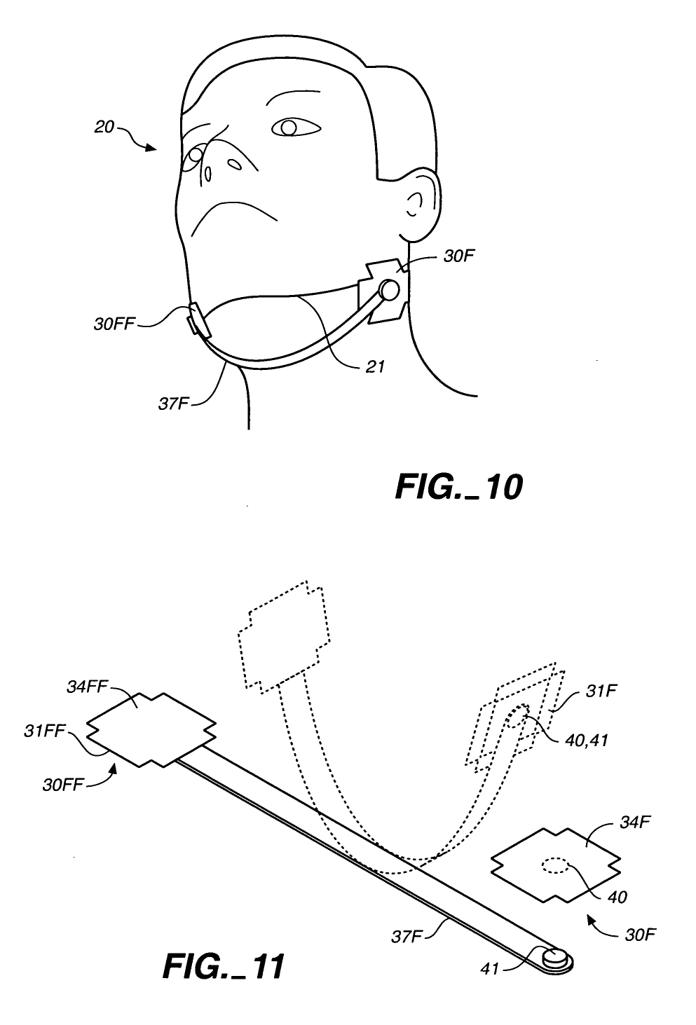

FIGS. 10 through 14, taken together, show the preferred embodiment of this invention. FIG. 10 shows a human, 20, with two adhesive anti-snoring patches, 30F and 30FF. These two patches are attached together by an elastic connector, 37F. The elastic connector attempts to separate 30F and 30FF and provides the required pulling force on each patch.

FIG. 11 illustrates the flexibility of the elastic connector, 37F. The solid line drawing shows elastic connector, 37F, when no force is being exerted. However, elastic connector, 37F, is a springy material and can elastically bend into the position shown by the dashed line drawing in FIG. 11. Successful tests have used strips of 0.75 mm thick polycarbonate plastic for connector, 37F.

For purposes of this invention terminology, this bent condition will be referred to as placing the “elastic connector in compression”. This terminology is used because alternative elastic connector materials, such a foam rubber, a metal spring, or a spring loaded linear device would be put in compression to generate the necessary pulling force. For consistency, bending 37F will also be considered placing 37F in compression.

In use, the two ends of elastic connector, 37F, are connected to the two patches, 30F and 30FF. One way of making this connection is to have the patches be pieces of tape and simply place each tip of 37F under the tape so that it is captured between the tape and the skin when the tape is attached to the skin. Other attachment devices such as a small hinge or a fixed connection are also possible.

The preferred connection method is to use magnets to make this connection. FIG. 11 illustrates the use of magnets. At the tip of each end of the elastic connector, 37F, there is a magnet 41. This magnet is visible in FIG. 11 because the patch, 30F, has been elevated for illustration purposes. The other end of the elastic connector, 37F, is similar, but the other magnet, 41, is hidden by patch, 30FF. There is another magnetic component, 40 attached to the back of patch 30F (shown better in FIG. 13). This magnetic component exhibits a magnetic attraction to magnet 41. Magnetic component 40 can be either iron or another magnet. Magnet 41 will attach to magnetic component 40 when they are brought close together. Patch 30FF has similar magnetic attachment means, but the magnets are hidden in FIG. 11.

In experiments, 40 and 41 were rare earth magnets, (NdFeB), each with a diameter of 12 mm and a thickness of 1.5 mm. These magnets should be oriented so that there is magnetic attraction between them.

In one test, the size of elastic connector, 37F, was adjusted so that it exerted a 0.65 Newton pulling force (about 65 gram force) on patches 31F and 31FF. This force was sufficient to open the blocked air passage for a person who suffers from obstructive sleep apnea. Less force would probably be required for a person with just a snoring problem.

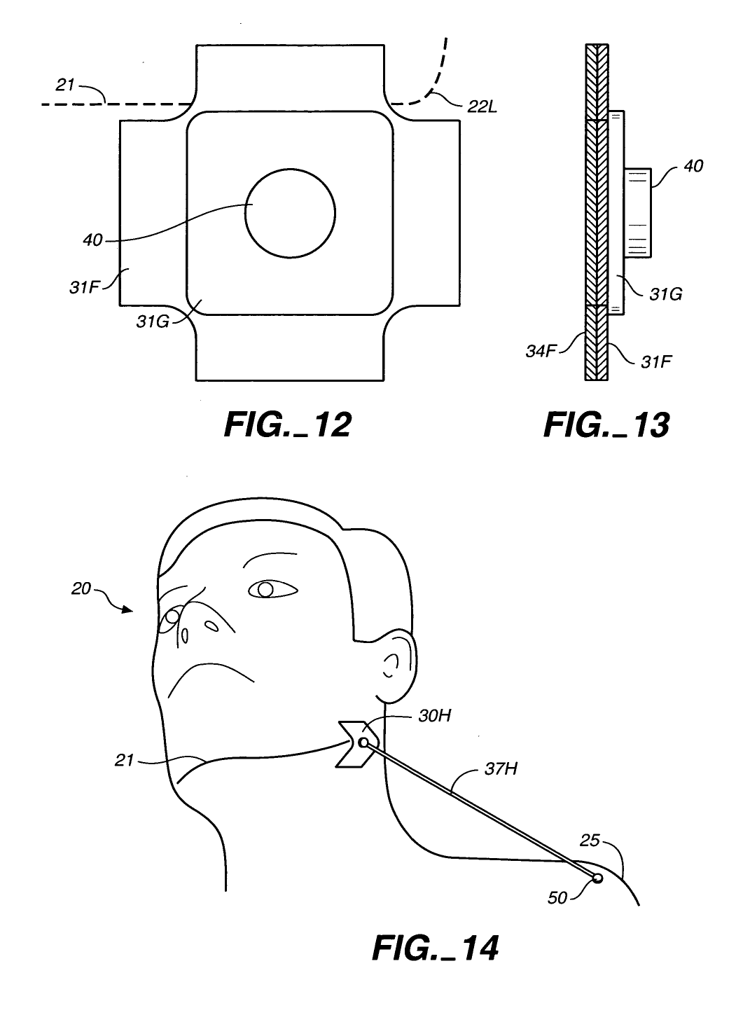

FIGS. 12 and 13 show details of the construction of patches 30F and 30FF. The thicknesses of components in FIG. 13 are exaggerated for clarity. Magnet, 40, is attached to support material 31G. This support material can be either rigid or flexible. In experiments, support 31G was 25 mm×25 mm×0.25 mm thick polycarbonate plastic. This plastic material is sufficiently rigid to maintain a generally flat shape when a 0.65 Newton pulling force is applied to the magnet, but the material is also sufficiently flexible so that a greater force will bend it.

There is a piece of tape attached to support 31G. This tape has a backing material, 31F and an adhesive layer, 34F. It should be mentioned that in this construction, both the tape backing material, 31F and the plastic, 31G, are considered “support members” because they both help to support the adhesive, 34F.

In FIG. 12, it can be seen that the tape with backing material, 31F, is shaped in the form of a cross with the arms of the cross extending beyond the edge of plastic, 31G. Extending the tape as shown is not essential, but it improves adhesion, comfort and reduces the required pulling force. The tape arms extending beyond the plastic are more flexible than the plastic and follow the stretched skin contour.

FIG. 10 shows how this combination appears when it is attached to a person. The connector, 37F, does not press against the skin under the jaw. It can either hang down or follow the jawbone line, 21. When applying this anti-snoring device, the two patches would be attached first, and then elastic connector, 37F, would be bent and attached using the magnets. In FIG. 10, patch, 31F, is illustrated as being positioned near the back edge of the neck inflatable area. This preferred placement is illustrated more clearly in FIG. 12. In FIG. 12, the jawbone line, 21, and the left end of the jawbone, 21L, are shown as a dashed line. The patch shape illustrated in FIGS. 12 and 13 has been optimized for this placement position. Other placements within the neck inflatable area and other patch shapes are also possible.

FIG. 14 shows an “elastic connector in tension” type anti-snoring device. Adhesive patch, 30H, is a piece of adhesive tape with a connection means such as a 6 mm diameter magnet captured between the tape and the skin. Elastic connector, 37H, in FIG. 14 is connected to an anchor point, 50, located on the shoulder, 25. The elastic connector, 37H, has been stretched so that it is in tension and exerts a pulling force on the neck inflatable area (not illustrated, but located under 30H). The elastic connector in tension, 37H, could be any material or device that can maintain a predetermined pulling force such as a rubber band or a spring. It would also be possible to use a device such as a spring loaded rewind spool similar to a rewind tape measure device.

The anchor point, 50, is shown on the shoulder, but this anchor point could be on other parts of the body such as the chest, back, or waist. The exact method of attaching to the anchor point is not important. For example, the anchor point is illustrated in FIG. 12 as if it were a real point. In practice, it could be any attachment means such as a loop under the arm.

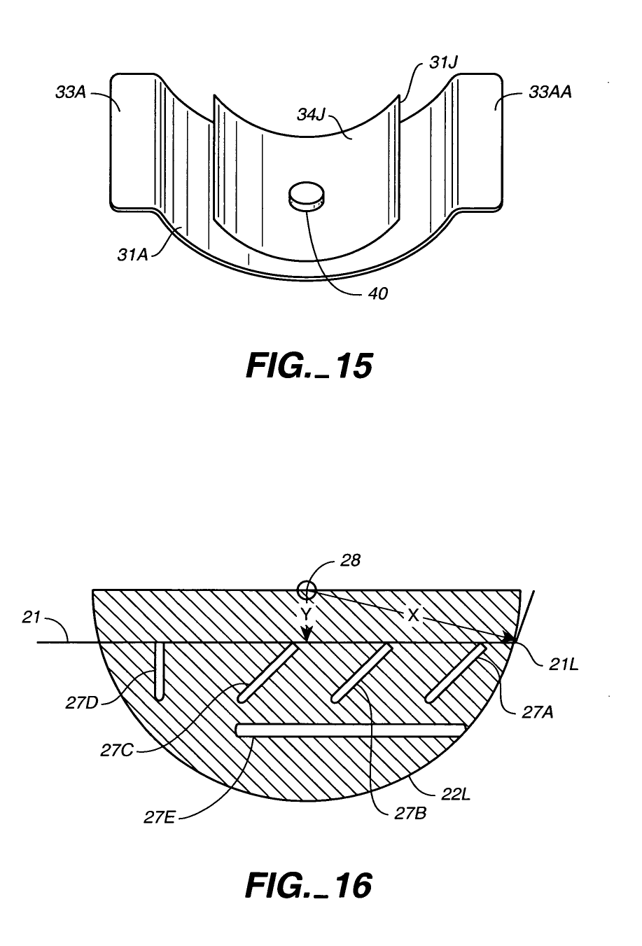

FIG. 15 shows an embodiment of this invention that is a combination of the bridge type neck anti-snoring device illustrated in FIGS. 2, 3 and 4 combined with some of the features of the devices illustrated in FIGS. 10 through 14. In FIG. 15, there is the bridge type support member, 31A, with pressure surfaces, 33A and 33AA. This is the same as was previously illustrated in FIG. 4. In FIG. 15, the bridge type support member 31A has been inverted for clarity compared to FIG. 4. Also, in FIG. 4, adhesive area 34A was part of double sided tape attached directly to support member, 31A. In FIG. 15, adhesive area 34J is the adhesive side of single sided tape. The backing material (support member), 31J, is hidden in FIG. 15, but it is the reverse side of the tape. This support member, 31J, is attached to support member 31A with magnets. One of the magnets, 40, is visible in FIG. 15. The other magnet, used for attachment, is hidden but it is equivalent to magnet, 41, in FIG. 11. The advantage of the approach illustrated in FIG. 15, is that the plastic support member, 31A, is reusable and it is easy for the user to replace the tape.

Previously, FIG. 1 gave a general description of the neck inflatable area. It is technically true that only the area below the jawbone line, 21, actually inflates when the throat is pressurized. However, there is a transition zone on the jaw that also exhibits some anti-snoring characteristics. The anti-snoring characteristic only shows up in this transition zone when the skin covering the lower jawbone is substantially stretched beyond its normal position. Therefore, the definition of the neck inflatable area includes this transition zone.

FIG. 16 shows an enlarged view of the left side of a person's jaw and neck. It helps to understand FIG. 16 by comparing it to FIG. 1. In both figures, there is a semicircular shaded area designated 22L and a jawbone line, 21, which ends at jawbone end 21L. In FIG. 16 the semicircular area, 22L, extends slightly above the jawbone line compared to FIG. 1. The semicircle in FIG. 16 will be used to define the neck inflatable area for purpose of this discussion. This semicircle has a 4 cm radius with a center point, 28. The center point, 28, is located 1 cm above the jawbone line, 21 (Y=1 cm). This semicircle also passes through the left end of the jawbone, point 21L. Therefore, the center point, 28, is located 4 cm from the end of the jawbone, 21L (X=4 cm).

While expanding most parts of the neck inflatable area has some anti-snoring effect, all areas of the neck inflatable area are not equally effective. Mapping the sensitivity of this area shows that within the neck inflatable area there are several sensitive areas that produce the greatest anti-snoring effect for the least expansion. These sensitive areas are designated 27A through 27E in FIG. 14. The first four are lines that start at the jawbone line, 21, and extend about 1 cm below the jawbone line. On a person with a jawbone size that is 10.8 cm from the left end of the jawbone, 21L, to the center of the chin, areas 27A, B, C, and D respectively intersect the jawbone line at about 0.6 cm, 2.4 cm, 4.1 cm and 6.4 cm from the left end of the jawbone, 21L. Sensitive area, 27E, is a line approximately 3 cm long. This line parallels jawbone line, 21, and lies about 1.7 cm below the jawbone line. It is desirable to target a specific sensitive area. For example, the cantilevered device in FIGS. 6 and 7 is designed to expand area 27E.

Most pressure sensitive adhesives are not reusable once they have been applied to skin. Therefore, if a non-reusable adhesive is utilized, it is necessary to discard at least the adhesive part of the anti-snoring device after a single use. If the entire anti-snoring device is inexpensive, then the entire anti-snoring device can be discarded. However, another alternative is to use single or double coated tape as previously discussed. This permits the replacement adhesive to be provided in a tape form with a release liner. The replacement tape could be precut into the optimum shape and attached to a release liner. The user would then remove the release liner and apply the tape appropriately.

Also, all the anti-snoring devices depicted here lack openings for ventilation. Experiments have given satisfactory results without providing any openings for ventilation, but these openings can easily be added without departing from the teachings provided herein. Pulling the skin in a part of the neck inflatable area also expands the skin in the surrounding area, so that openings can be accommodated.

Finally, it should be noted that all the neck patch anti-snoring devices described herein have the following common elements:

There is at least one adhesive coated support element.

In use, at least a part of the adhesive coated support element is attached to at least a part of a neck inflatable area on a human.

There is a bias means for providing a predetermined pulling force on the support element to cause at least a portion of the neck inflatable area to expand outward by at least 2.5 mm from its normal position.

The expansion of the neck inflatable area modifies the throat such that the human exhibits a substantial reduction in snoring while sleeping.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. An anti-snoring device comprising:
at least one adhesive coated support member; and
means for exerting a predetermined pulling force on said adhesive coated support member such that when said adhesive coated support member is attached to a neck inflatable area of a human, said pulling force expands at least a portion of the neck inflatable area and causes a reduction in snoring in the human.

2. The apparatus of claim 1 where said means for exerting said predetermined pulling force includes a bridge type anti-snoring apparatus with two pressure surfaces, and at least one of said pressure surfaces exerts a pushing force on a jawbone area of the human.

3. The apparatus of claim 1 where said means for exerting said predetermined pulling force includes a cantilever type anti-snoring apparatus which exerts a pushing force on a jawbone area of said human and also exerts a pulling force on a cheek area of the human.

4. The apparatus of claim 1 where said means for exerting a predetermined pulling force includes a support member of predetermined weight, such that gravity acting on said support member is sufficient to expand a portion of the neck inflatable area of the human by more than 2.5 mm from the neck inflatable area's normal position.

5. The apparatus of claim 1 where said means for exerting a predetermined pulling force includes an elastic connector means in compression attached to two adhesive coated support members.

6. The apparatus of claim 1 where said means for exerting a predetermined pulling force includes an elastic connector means in tension which is attached to both an anchor point on the human and attached to said support member.

7. An apparatus for treatment of snoring in a human, said apparatus comprising:
at least one support element;
adhesive means for attaching at least a part of said support element to at least a part of a neck inflatable area on a human; and
bias means to provide a predetermined pulling force to cause at least a portion of the neck inflatable area to expand outward by at least 2.5 mm from its normal position, wherein the expansion of the neck inflatable area modifies the throat such that the human exhibits a substantial reduction in snoring while sleeping.

8. An apparatus for treatment of snoring in a human, said apparatus comprising:
a support member having an inside surface;
adhesive means for adhering said support member inside surface to a neck inflatable area of a human; and
bias means for applying a pulling force to said support member and to the neck inflatable area.

9. The apparatus for treatment of snoring in a human of claim 8 wherein said support member comprises a flexible support member.

10. The apparatus for treatment of snoring in a human of claim 8 wherein said support member comprises a bridge type neck patch.

11. The apparatus for treatment of snoring in a human of claim 8 wherein said support member comprises a cantilevered type neck patch.

12. The apparatus for treatment of snoring in a human of claim 8 wherein said support member comprises a weighted neck patch.

13. The apparatus for treatment of snoring in a human of claim 8 wherein said support member comprises a neck patch attached to an elastic connector in tension.

14. The apparatus for treatment of snoring in a human of claim 8 wherein said support member comprises a pair of patches connected together by an elastic connector in compression.

15. The apparatus for treatment of snoring in a human of claim 8 wherein said support member and said adhesive means comprise a piece of tape.

16. A method for treatment of snoring, said method comprising the steps of:
providing at least one support member;
adhering the at least one support member to at least one of a user's two neck inflatable areas; and
applying a predetermined pulling force to the at least one support member to cause at least a portion of a neck inflatable area to expand outward by at least 2.5 mm and open the air passage in the user's throat.

17. The method for treatment of snoring of claim 16 wherein said step of providing a support member comprises providing a bridge type patch.

18. The method for treatment of snoring of claim 17 wherein said step of adhering the support member to a user's neck inflatable area comprises flattening the bridge type patch against the user's skin proximate the neck inflatable area.

19. The method of claim 16 where said step of providing at least one support member includes providing two support members, and said step of adhering to at least one of a user's two neck inflatable areas includes the step of adhering one of said support members to each of the user's two neck inflatable areas.

20. The method for treatment of snoring of claim 19 wherein said step of applying a predetermined pulling force includes providing an elastic connector in compression and attaching said connector to the two support members.

21. The method for treatment of snoring of claim 20 wherein said step of attaching said connector to the support members comprises attaching the connector with magnets.

22. The method for treatment of snoring of claim 16 wherein said step of providing at least one support member comprises providing a cantilevered type patch.

23. The method for treatment of snoring of claim 16 wherein said step of providing a support member comprises providing a weighted patch.

24. The method for treatment of snoring of claim 16 further including the step of providing a bridge type device spanning the support member and said step of applying a predetermined pulling force comprises attaching the support member to the bridge type device.
